(19) United States
(12) Patent Application Publication
(10) Pub. No.: US 2018/0240450 A1
(43) Pub. Date: Aug. 23, 2018

(54) SOUNDPROOF STORAGE CONTAINER

(71) Applicant: David Everhart Moran, JR., Newtown Square, PA (US)

(72) Inventor: David Everhart Moran, JR., Newtown Square, PA (US)

(21) Appl. No.: 15/728,680

(22) Filed: Oct. 10, 2017

Related U.S. Application Data
(60) Provisional application No. 62/461,315, filed on Feb. 21, 2017.

(51) Int. Cl. G10K 11/16; B65D 43/16; B65D 25/14; B65D 25/20; B65D 6/02; H04R 1/02

(52) U.S. Cl. CPC G10K 11/16; B65D 43/163; B65D 25/14; H02J 7/025; B65D 9/06; H04R 1/028; B65D 25/20

(57) ABSTRACT

The present invention provides a soundproof storage container for preventing unauthorized eavesdropping via a hacked electronic device. The soundproof storage container includes a housing comprising a base, a sidewall forming an interior volume, and a lid hingedly affixed to the sidewall. The housing further includes a soundproof liner disposed between an interior surface and an exterior surface of the housing, such that the soundproof liner extends the entirety of the housing. A microphone is disposed on the interior surface of the housing and a speaker is disposed on the exterior surface of the housing, wherein the speaker is operably connected to the microphone. Both the speaker and microphone are operably connected to a power source disposed within the housing. In an alternate embodiment, a wireless charging mat and at least one charging port are disposed on the base of the housing, wherein each is operably connected to the power source.

### CROSS REFERENCE TO RELATED APPLICATION

This application claims the benefit of U.S. Provisional Application No. 62/461,315 filed on Feb. 21, 2017. The above identified patent application is herein incorporated by reference in its entirety to provide continuity of disclosure.

### BACKGROUND OF THE INVENTION

The present invention relates to electronic device storage containers. More specifically, the present invention provides a soundproof storage container for safeguarding against a potentially hacked electronic device in order to prevent eavesdropping of a confidential conversation by an unauthorized intruder.

Most electronic devices are linked to the internet through a wireless network or a Wi-Fi signal. Because of this, these electronic devices are susceptible to hacking by unauthorized intruders. Specifically, mobile devices, such as smartphones, are highly targeted by hackers to eavesdrop on confidential conversations. Many times, a hacked smartphone will go unnoticed and confidential information may be acquired and leaked by the hacker. This confidential information includes topics such as, trade secrets, stock information, bank account information, or personal identifying information. Therefore, a device providing a soundproof barrier that prevents unauthorized individuals from using a hacked mobile device to eavesdrop on a confidential conversation is needed.

Devices have been disclosed in the known art that relate to electronic device storage containers. These include devices that have been patented and published in patent application publications. These devices generally relate to wireless device storage boxes that are used to deactivate a phone while a user is driving. Other similar storage boxes prevent magnetic fields or other signals from effecting a mobile device.

These known art devices have several known drawbacks. Some of these devices require the electronic device to be completely deactivated, preventing a user from receiving any type of notification from the device. Further, some of these devices completely prevent sound from penetrating the housing of the storage container. Moreover, these types of containers do not include a means to notify a user that a mobile device inside the container is ringing or if a text is received. Lastly, these known devices do not include wireless charging technology within the storage container that can be utilized to charge an electronic device while being stored.

In light of the devices disclosed in the known art, it is submitted that the present invention substantially diverges in design elements from the known art and consequently it is clear that there is a need in the art for an improvement to existing electronic device storage containers. In this regard the instant invention substantially fulfills these needs.

### SUMMARY OF THE INVENTION

In view of the foregoing disadvantages inherent in the known types of electronic device storage containers now present in the known art, the present invention provides a new soundproof storage container wherein the same can be utilized for providing convenience for a user when preventing a hacked smartphone from being utilized to eavesdrop on a confidential conversation.

It is therefore an object of the present invention to provide a new and improved soundproof storage container that has all of the advantages of the known art and none of the disadvantages.

It is another object of the present invention to provide a soundproof storage container comprising a housing having a base, a sidewall forming an interior volume, and a lid hingedly affixed to the sidewall. The housing further includes a soundproof liner disposed between an interior and exterior surface of the housing, a microphone disposed on the interior surface of the housing, and a speaker disposed on the exterior surface of the housing, wherein the microphone and speaker are operably connected to a power source.

Another object of the present invention is to provide a soundproof storage container, wherein a wireless charging mat is disposed on the base within the interior volume of the housing and operably connected to the power source.

Yet another object of the present invention is to provide a soundproof storage container, wherein at least one charging port is disposed within the interior volume of the housing and operably connected to the power source.

Another object of the present invention is to provide a soundproof storage container that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the soundproof storage container.

FIG. 2 shows a top view of an embodiment of the soundproof storage container, wherein a wireless charging mat and a plurality of charging ports are disposed in the interior of the device.

FIG. 3 shows a perspective view of an embodiment of the soundproof storage container, wherein the lid is closed.

### DETAILED DESCRIPTION OF THE INVENTION

Reference is made herein to the attached drawings. Like reference numerals are used throughout the drawings to depict like or similar elements of the soundproof storage container. For the purposes of presenting a brief and clear description of the present invention, the preferred embodiment will be discussed as used for safeguarding against a potentially hacked smartphone. The figures are intended for representative purposes only and should not be considered to be limiting in any respect.

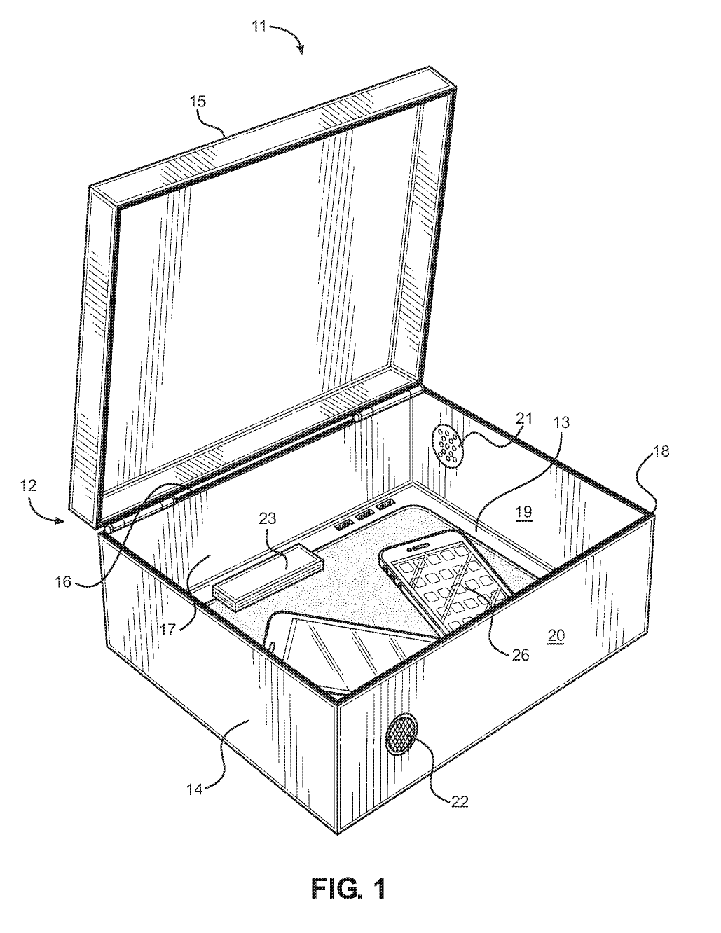

Referring now to FIG. 1, there is shown a perspective view of an embodiment of the soundproof storage container. The soundproof storage container 11 includes a housing 12 having a base 13, a sidewall 14 forming an interior volume, and a lid 15 hingedly affixed to the sidewall. In the illustrated embodiment, the housing 12 is cube shaped and includes a plurality of sidewalls 14, wherein the lid 15 is hingedly attached to an upper edge 16 of a first sidewall 17. However, the housing 12 is not limited to this specific shape and can be any shape, such as, cylindrical or rectangular.

The soundproof storage container 11 further includes a soundproof liner 18 disposed between an interior surface 19 and an exterior surface 20 of the housing 12, such that the soundproof liner 18 extends along the entirety of the housing 12. The interior surface 19 and the exterior surface 20 include the surfaces of the base 13, the sidewalls 14, and the lid 15. The soundproof liner 18 is configured to prevent sound from penetrating the walls of the housing 12. The interior surface 19 and exterior surface 20 of the housing are constructed of a rigid material, such as wood, in order to maintain the structure of the container 11 while further providing an additional barrier around the soundproof liner 18.

The soundproof storage container 11 further includes a microphone 21 disposed on the interior surface 19 of the housing 12, wherein the microphone 21 is configured to pick up sound within the container 11. A speaker 22 is disposed on the exterior surface 20 of the housing 12 and operably connected to the microphone 21. The speaker 22 is configured to transmit an alert when sound is received by the microphone 21 within the container 11. The alert notifies a user that a mobile device within the container has received a text or phone call, while still preventing sound from penetrating the soundproof liner 18 of the container 11.

In the illustrated embodiment, the microphone 21 and speaker 22 are disposed on the interior surface 19 and exterior surface 20 of a sidewall 14, respectively. However, this does not limit each to being disposed on the sidewall, rather the microphone 21 can be disposed anywhere on the interior surface 19 of the housing 12 and the speaker can be disposed anywhere on the exterior surface 20 of the housing 12. In another embodiment, the speaker 22 is configured to transmit the actual sound picked up by the microphone 21 to the outside of the container 11. This configuration allows a user to hear the ringing phone or receive a text notification from the smartphone through the speaker 22, while still preventing any sound from penetrating the soundproof liner 18. In this way, the sound from mobile phones having varied ring tones would be distinguishable coming through the speaker 22.

Both the microphone 21 and speaker 22 are operably connected to a power source 23, wherein the power source 23 is disposed within the interior of the housing 12. In the illustrated embodiment, the power source 23 is configured as a rechargeable battery to allow the container 11 to be portable. However, in an alternative embodiment, the power source 23 can be in the form of an electrical cord and plug that can be attached to an electrical outlet. Further, in an alternative embodiment, the housing may include more than one speaker and microphone.

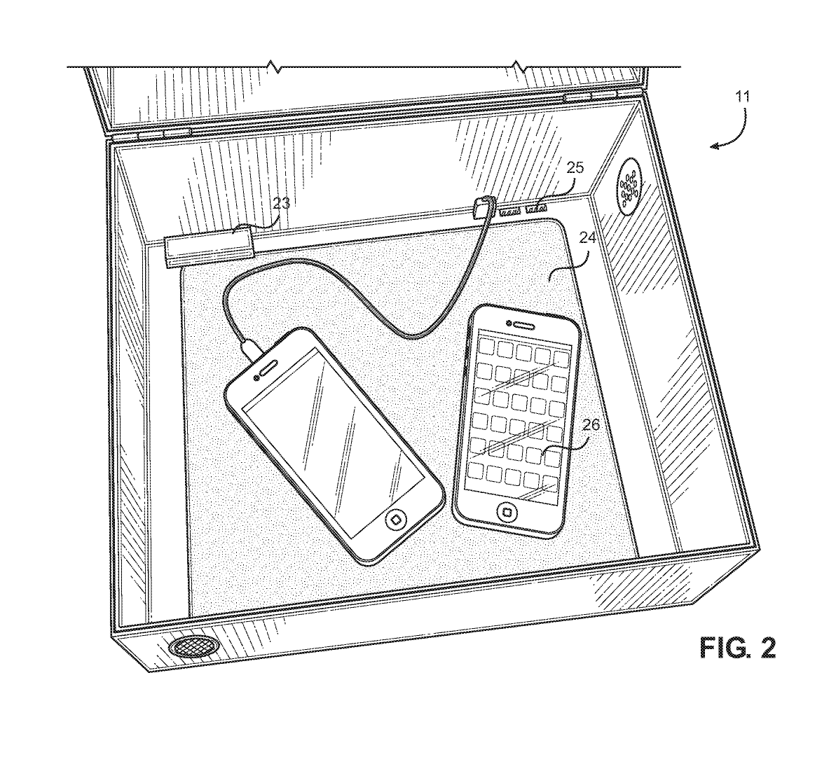

Referring now to FIG. 2, there is shown a top view of an embodiment of the soundproof storage container, wherein a wireless charging mat and a plurality of charging ports are disposed in the interior of the device. In the illustrated embodiment, the soundproof storage container 11 further includes a wireless charging mat 24 disposed on the base within the interior volume of the housing, wherein the wireless charging mat 24 is operably connected to the power source 23. The wireless charging mat 24 is utilized to wirelessly charge a smartphone 26 that is stored within the container 11. This prevents a battery of the smartphone 26 stored within the container 11 from depleting. In the illustrated embodiment, the wireless charging mat 24 is square and covers a substantial portion of the base. However, in alternative embodiments, the wireless charging mat can be any shape and cover any portion of the base.

In the illustrated embodiment, the soundproof storage container 11 further includes at least one charging port 25 disposed within the interior volume of the housing, wherein the charging port 25 is operably connected to the power source 23. This allows a smartphone that is incapable of being wirelessly charged to be charged through a standard charging cable attached to one of the charging ports 25.

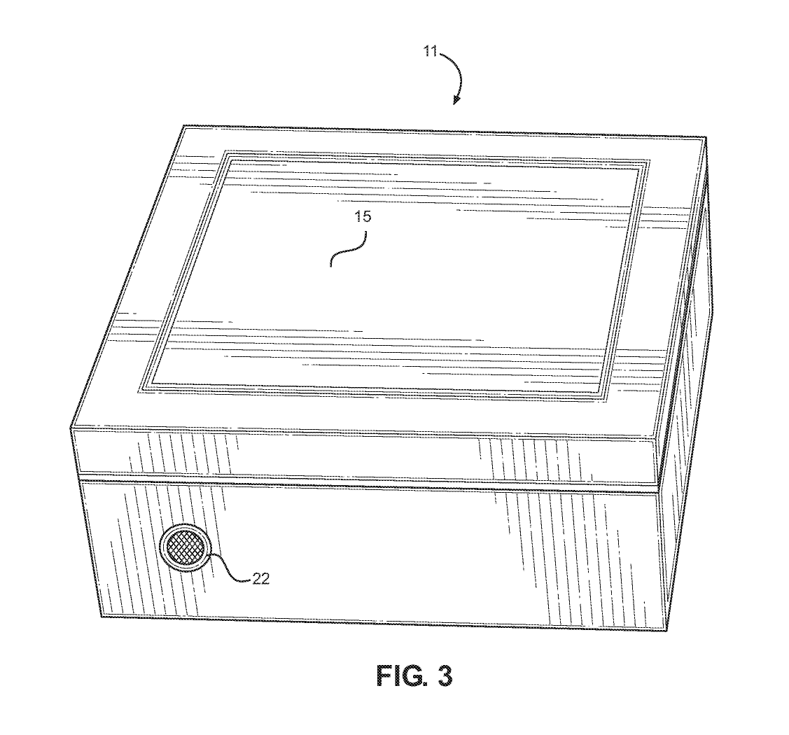

Referring now to FIG. 3, there is shown a perspective view of an embodiment of the soundproof storage container, wherein the lid is closed. When the lid 15 is in a closed position, the faces of the soundproof liner of the lid and sidewalls meet, wherein each face rests flush with one another, thereby creating a sound proof barrier that prevents any sound from entering into the interior of the housing wherein an electronic device is stored. This prevents a hacked cell phone or other electronic device from receiving any sound from outside the container, such that the audio from a conversation occurring on the outside of the container 11 cannot be picked up by a microphone of an electronic device within the container 11. In an alternative embodiment, the soundproof includes a locking mechanism, such as a lock and key, that can secure the devices within the container 11. This further prevents an intruder from physically accessing the electronic devices stored within the container when left unsupervised.

The speaker 22 on the exterior of the container allows a user to be notified via an alert if the electronic device receives a text or phone call. This operation is performed by utilizing the microphone within the interior of the container 11 to receive the sound and transmit an alert through the speaker 22. This configuration only allows an alert or sound to travel out of the container 11 through the speaker 22 while preventing any sound from traveling into the container 11, thus preventing a hacked phone from receiving any audio from outside the container 11. This allows a user to maintain the ability to be notified if a phone call or text is received, while preventing any eavesdropping on a confidential conversation.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A soundproof storage container, comprising:
a housing having a base, a sidewall forming an interior volume, and a lid hingedly affixed to the sidewall;
a soundproof liner disposed between an interior surface and an exterior surface of the housing;
a microphone disposed on the interior surface of the housing;
a speaker disposed on the exterior surface of the housing, wherein the speaker is operably connected to the microphone; and
a power source, wherein the microphone and the speaker are operably connected to the power source.

2) The soundproof storage container of claim 1, wherein a wireless charging mat is disposed on the base within the interior volume of the housing and operably connected to the power source.

3) The soundproof storage container of claim 1, wherein at least one charging ports disposed within the interior volume of the housing and operably connected to the power source.

4) The soundproof storage container of claim 1, wherein the housing is cube shaped.

5) The soundproof storage container of claim 1, wherein the housing is constructed of a rigid material.

6) The soundproof storage container of claim 5, wherein the rigid material is wood.
